(19) United States
(12) Patent Application Publication
(10) Pub. No.: US 2013/0007147 A1
(43) Pub. Date: Jan. 3, 2013

(54) TECHNIQUES FOR EXTENDING AND ASSOCIATING CHATS WITH EXECUTION INSTANCES OF PROGRAMS

(76) Inventors: James Toga, Wayland, MA (US); Siddhartha Gupta, Needham, MA (US); Dmitry Orlovsky, Brookline, MA (US); Paul Ramos, Marlborough, MA (US); David Verratti, Austin, TX (US)

(21) Appl. No.: 13/239,641

(22) Filed: Sep. 22, 2011

Related U.S. Application Data
(60) Provisional application No. 61/385,497, filed on Sep. 22, 2010.

(51) Int. Cl. G06F 15/16

(52) U.S. Cl. 709/206

(57) ABSTRACT

Methods and apparatus, including computer program products, for extending and associating chats with execution instances of programs. A method includes, in a computer system, extending and associating chats with execution instances of programs.

### CROSS-REFERENCE TO RELATED APPLICATIONS

This application claims the benefit of U.S. Provisional Application No. 61/385,497, filed Sep. 22, 2010, and titled TECHNIQUES FOR EXTENDING AND ASSOCIATING CHATS WITH EXECUTION INSTANCES OF PROGRAMS, which is incorporated by reference in its entirety.

### BACKGROUND OF THE INVENTION

The invention generally relates computer systems and computer executed methods for extending and associating chats with execution instances of programs.

Online chat may refer to any kind of communication over the Internet, that offers an instantaneous transmission of text-based messages from sender to receiver, hence the delay for visual access to the sent message shall not hamper the flow of communications in any of the directions. Online chat may address as well point-to-point communications as well as multicast communications from one sender to many receivers.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for extending and associating chats with execution instances of programs.

In general, in one aspect, the invention features a method including, in a computer system, extending and associating chats with execution instances of program.

### BRIEF DESCRIPTION OF THE DRAWINGS

The invention will be more fully understood by reference to the detailed description, in conjunction with the following figures, wherein:

FIG. 1 is a flow diagram.

FIG. 2 is an exemplary user interface (UI).

FIG. 3 is exemplary HTML.

FIG. 4 is a flow diagram.

FIG. 5 is an exemplary UI.

FIG. 6 is a flow diagram.

FIG. 7 is a flow diagram.

FIG. 8 is a flow diagram.

FIG. 9 is a flow diagram.

FIG. 10 is an exemplary UI.

FIG. 11 is an exemplary UI.

FIG. 12 is an exemplary UI.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

PCT/US09/54782, Gupta et al., “Techniques for extending and associating chats with execution instances of programs,” filed Aug. 24, 2009, has inventors and an assignee in common with the present non-provisional application. The complete specification and drawings of PCT/US09/54782 (referred to herein as “the chat application”) are incorporated by reference into the present non-provisional application for all purposes.

The chat application describes a system and technique for associating a chat with a plurality of execution instances of a program, in which an observation is made of observable information in an execution instance, and for the execution instance a mapping is made of the observation to a chat by a predetermined method; a chat is usable for communication by the instances and/or entities associated with the instances. In the techniques of the chat application, an observer that is separate from the instance of the program execution makes the observations of the instance. Disclosed in the chat application are implementations of the techniques in which the observer is a web browser extension, such as a plug-in, or a web browser. The observer uses the browser's interface for notifying an extension of events in the browser to make observations about webpages being interpreted by an execution instance of the browser. The observations are then mapped to the chat. A mapping may manipulate the observation and maybe implemented using any information available to the observer. In some embodiments, the chat may have a persistence that is greater than that of the instances associated with it. The techniques of the chat application were not limited to use with chats, but could be used with other kinds of channels for communication.

In the context of the chat application, an observer making an observation did not substantially alter the behavior of the execution instance of which the observer made an observation.

In embodiments of the chat application, a browser extension, also referred to in the present context as an observer extension or plug-in, makes observations of observable information of instances of executions of Web applications executing in a browser. Based on information of an observation, the observer extension maps the observation to a chat, and makes the chat available to the user of the execution instance. For example, a chat may be a chat that may be used by users interested in a particular live sporting event, some of whom are viewing the live event by means of a webpage rendered by a web browser. Users who have access to the chat may then chat with each other about the event, such as while they are viewing the event.

In embodiments of the chat application, UI elements for manipulating an aspect of the chat may be displayed by the plug-in in a toolbar of the web browser. For example, a plug-in may display in the toolbar a number of UI icons for muting voice import, controlling volume, or disconnecting from a chat. In some embodiments of the system and techniques of the chat application, a chat could be accessible also to a second user or entity having a facility for accessing the chat. For example, a chat could be accessible to a second user via a dial-in telephone call to a particular number for a second user had a telephone.

Experience with embodiments of the invention of the chat application showed that while the techniques were powerful and useful in many ways, there were nonetheless a number of limitations, including things that the techniques of the chat application could not do. Among these limitations were the following:

One thing the techniques of the chat application could not do was to alter substantially the behavior of the execution instance of which observations were made. For example, the techniques of the chat application could not change the execution instance of a particular webpage in the browser to carry out an action to modify an aspect of a chat that had been associated with the execution instance by action of the observer.

Another thing the techniques of the chat application could not do was to modify the UI of the execution instance of which observations were made in a fashion determined by information of the observations. For example, the techniques of the chat application could not add UI elements to or substantially alter the behavior of the UI elements of a webpage in an execution instance of which observations were made to provide the user with UI elements for modifying an aspect of a chat that had been associated with the execution instance by action of the observer.

A further thing the chat application techniques could not do was to provide the user with means to make a chat available to a desired second user or entity when the desired second user or entity did not already have a necessary facility for accessing the chat. For example, the techniques of the chat application did not include causing a resource reference or object to be made available to a desired second user or entity that did not have access to the chat so that the user or entity could access the chat using the resource reference or object.

The purposes of the present invention include providing techniques for overcoming these and other limitations of the system and techniques of the chat application.

As is known in the art, many web browsers render a webpage such as an HTML webpage of a web application for presentation to a user by constructing a DOM model for the webpage, and rendering the DOM model for the user. Web browsers, HTML, DOM models, APIs of web browser such as JavaScript APIs, APIs of a web browser for obtaining information of a DOM model and modifying the DOM model, text chats as used in the present context, among other aspects of the implementation, are well known and readily understood, and thus need not be described here. Accordingly, such details are omitted for brevity. Further aspects of the implementation that are well known or readily understood from disclosures of the chat application that is incorporated in the present application also need not be described here, and are also omitted for brevity.

In a preferred embodiment of the present invention, a browser extension makes observations of observable information of instances of executions of Web applications executing in a web browser, and may perform any or all of the functionality of the embodiments of the chat application, such as mapping and observation to a chat and making the chat available to a user. In one form of a preferred embodiment, the web browser is the Firefox web browser. Further, the extension may make changes to the DOM model created by the browser for a webpage. The extension uses well-known APIs of the web browser such as JavaScript APIs to obtain information and to modify the DOM model, the modifications being determined at least in part by information of an observation. As is readily understood concerning web browsers, the web browser will subsequently render the DOM model for the user as it has been modified. In the present context, the extension may be referred to as an observer/extender extension. The observer/extender extension uses an SDK for implementing voice chats. SDKs and JavaScript APIs are well known and readily understood. In a preferred embodiment, an SDK for the Vivox voice network is employed.

DOM models for HTML webpages have head and body portions, as well as further portions, as is well known.

A presently preferred embodiment is intended to be used with the Facebook web application, a well-known social networking web application.

In a preferred embodiment, the browser extension registers a callback function with the browser, and the browser associates the callback function with a browser event for loading a new webpage. For convenience, the callback function may be referred to in this context as an onLoad function. The onLoad function is called by the browser when the event occurs of loading a new webpage in the browser. Using well-known APIs of the browser, the onLoad function makes an observation of observable information associated with the webpage where the event, such as the type of page or object being loaded, the URL address of the page being loaded, and information of the DOM model.

The callback function has access to a number of modifications for modifying a DOM model in a particular way. The onLoad function determines from the information of the observation whether the page is a page for which the extension as a modification script, and if so, obtains a handle or reference to the modification script, and associates the script with the DOM model.

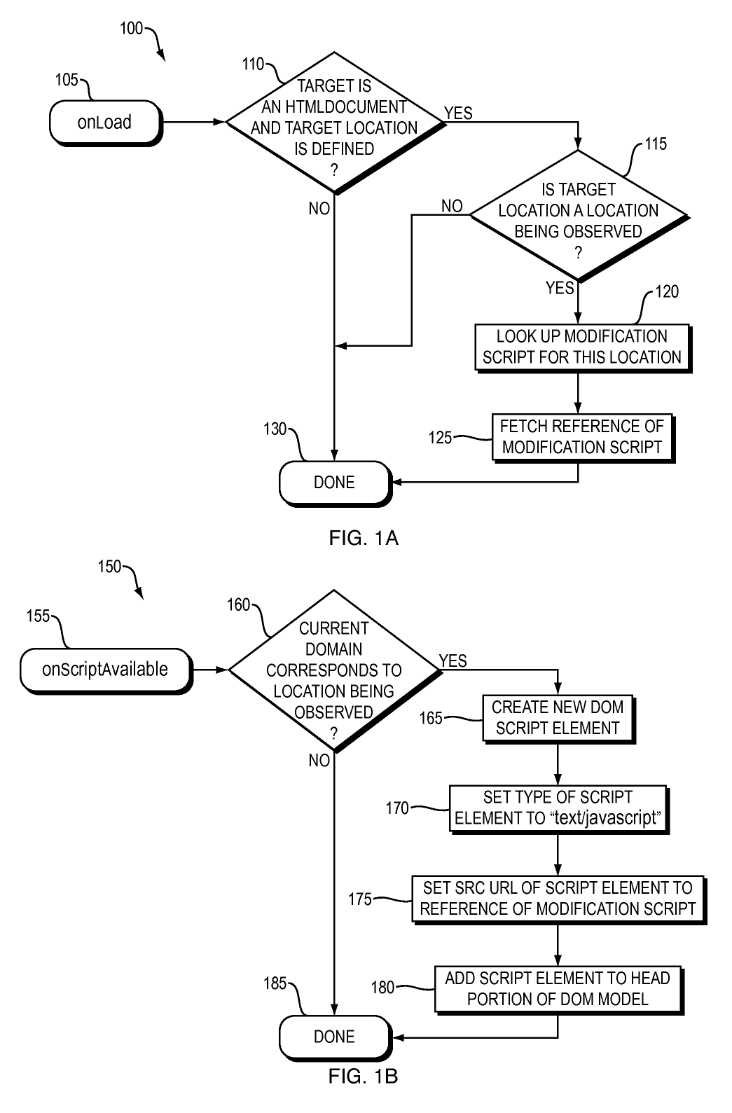

An exemplary embodiment of the onLoad function is shown in flowchart form at 100 in FIG. 1 starting at 105. As shown at 110, the function determines whether the target information for the current page indicates that the target is of kind HTMLdocument and that the location of the target is defined. If not, the function is done, as shown at 130. If so, at 115 the function determines whether the location is a location for which the extension should make an observation. If not, the function is done at 130. If so, at 120 the function looks up the appropriate modification script intended for use with this location, and at 125 fetches a reference to the modification script and stores it for later use, and the function is done at 130.

Subsequent to performing the steps of the onLoad function, the extension calls a further function onScriptAvailable, showing in exemplary fashion as a flowchart at 150 in FIG. 1 starting at 155, to determine whether the modification script is to be used with the DOM model for the current webpage. As shown at 160, a function determines whether the domain portion of the URL of the current page corresponds to a location for which the extension should potentially modify the DOM model. If not, the function is done as shown at 185. If so, at 165 the function creates a new DOM script element; at 170 the function sets the type value for the element to “text/javascript;” at 175 the function sets the source URL value of the script element to a reference to modification script that should be run; finally at 180, the function adds the script element to the head portion of the DOM model for the current page, and the function is done at 185.

As will be readily understood, the browser subsequently executes the steps of the modification script and subsequently renders or re-renders the DOM model for the user. In a preferred embodiment the modification script is executed periodically via a timer-based callback, or alternatively may be executed in response to a change in the DOM model or in another fashion.

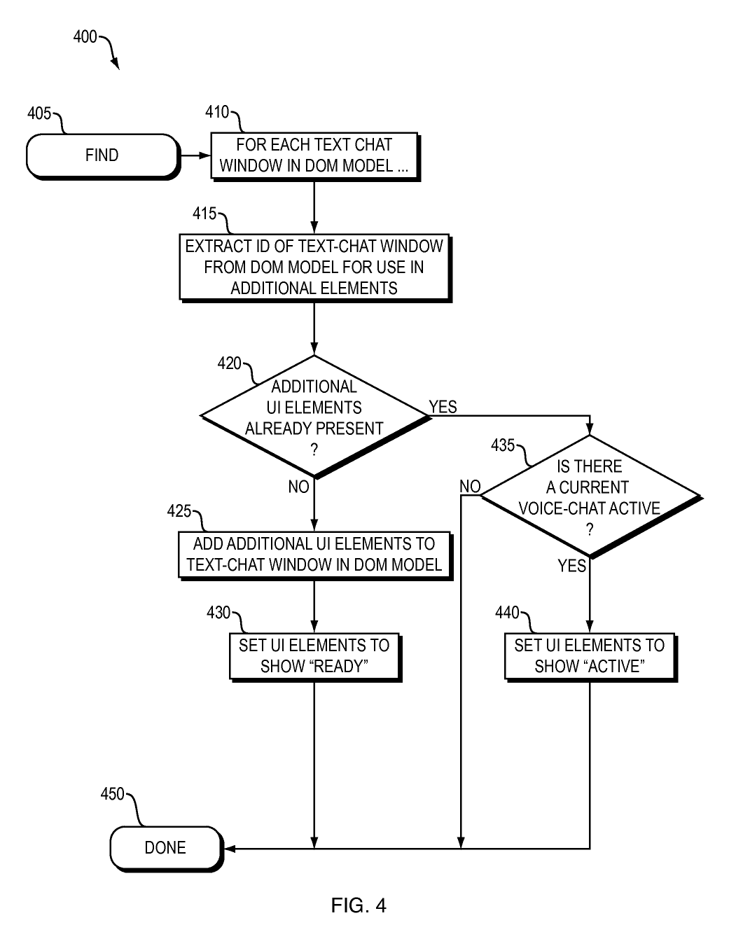

As will be described in exemplary fashion in FIG. 4, the modification script modifies the information of the DOM model that the browser renders for the user. The modification script determines whether specific UI elements of a text chat window for a portion of the Facebook web application are present in the DOM model. If so, the modification script adds a number of additional UI elements to the DOM model in specific relation to other specific UI elements of the text chat window. UI elements added by the modification script are also associated by the modification script with scripts for accessing a voice chat, such as initiating, receiving, or leaving a voice chat, providing means to access to the voice chat to another Facebook user, or muting voice input to the chat.

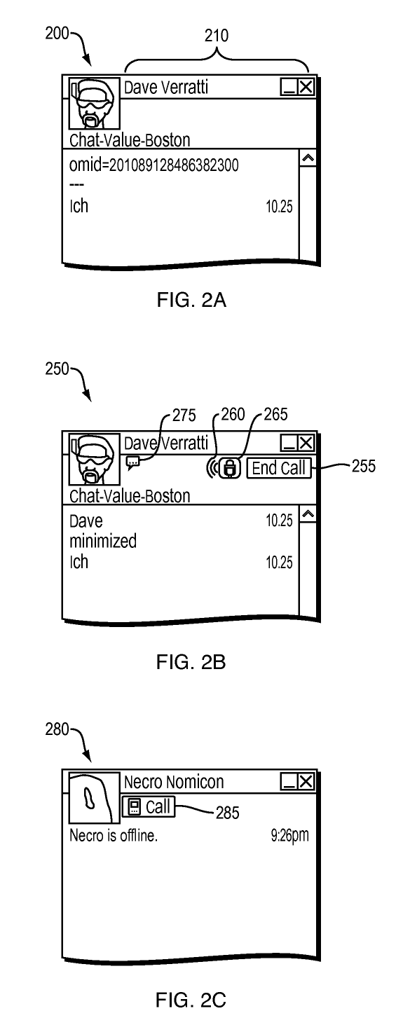

FIG. 2 shows exemplary views of the rendering of the DOM model for the webpage by the browser as it would appear to a user; 200 shows a rendering of an instance of the DOM model before the additions made by the modification script, and 250 and 280 show renderings of instances of the DOM model after the modification script has made the additions. In these examples, 280 shows an example for the modified UI model before the present user has initiated a call. Also visible is additional call icon 285 for initiating a voice chat call.

250 in FIG. 2 shows an example for the modified DOM model after a call has been initiated and before the user has hung up from the voice chat call. Visible are speaking indicator icon 275 indicating that the other user with whom the present user is speaking in a voice chat is speaking, mute/unmute icon 265 that the present user may click to mute/unmute her own microphone, mute/unmute status icon 260 indicating that the present user's microphone is not muted, and end call icon 255 that the present user may click to disconnect from or terminate use of the voice chat.

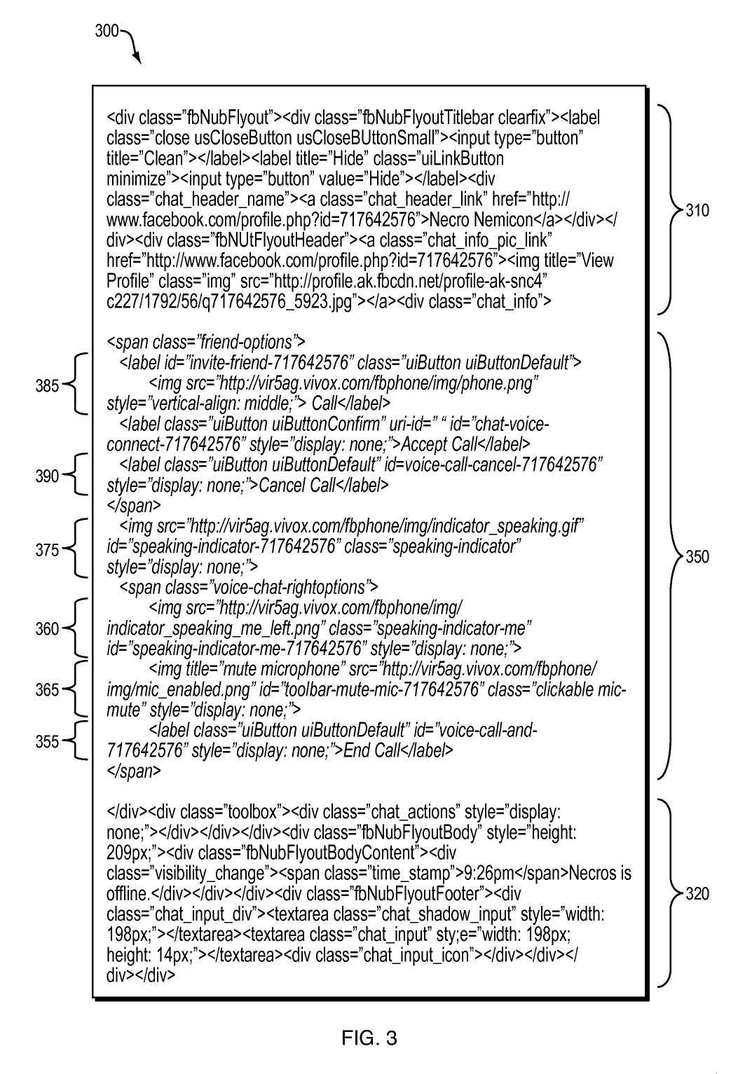

FIG. 3 at 300 shows, in the form of HTML, exemplary additions by the modification script to the DOM model in context with original portions of the DOM model. 310 and 320 illustrate original portions of the DOM model: portion 350 of the HTML shows additions made by an exemplary modification script. Visible in portion 350 are portion 385 for a call icon, portion 375 for a speaking indicator icon for another user, portion 360 for a mute/unmute status icon, portion 365 for a mute/unmute icon, and portion 355 for an end call icon. Also visible are portions such as portion 390 for a cancel call icon.

As is well known, portions of the DOM model may be made visible/active or not visible/not active by the APIs of Web browsers, scripts or actions may be performed in response to an event of the web browser, including events of a periodic timer, and a periodic timer may be employed to call a function to determine and/or respond to changes in state, such as the state of a voice chat.

FIG. 4 at 400 shows in exemplary flowchart form a modification script of a preferred embodiment. In this example, the script name find at 405 contains steps to be performed for each text chat window in the DOM model, as shown at 410. At 415, the script extracts the ID of a text chat window from the DOM model: the value of the ID is available to be used in other steps. Subsequently at 420, the script determines whether the additional UI elements added by steps of the script are already present in the DOM model. If not, at 425 the script adds the additional elements to the text chat of the DOM model, subsequently at 430 sets the UI elements to indicate a “ready” state in which the user may engage in a voice chat, and at 450 the function is done. If the elements are already present, at 435, the script determines whether there is currently a voice chat active for the text chat window, and if so at 440 sets the UI elements to indicate that there is an active voice chat. Subsequently the function is done at 450.

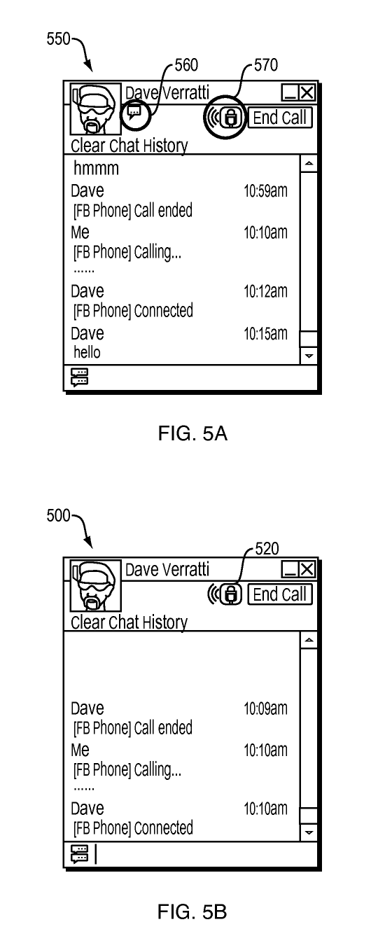

FIG. 5 shows views 550 and 500 of further exemplary instances of a rendering of a DOM model with UI elements added by a modification script according to a form of the presently preferred embodiment, illustrating a preferred form for indicating whether users participating in a voice chat are speaking Visible in view 550 is indicator icon 560, indicating that the user's name and image are shown is speaking audibly in the voice chat. Visible in 500 at 520 and in view 550 at 570 is further indicator icon showing that the user of the browser in which the icons are shown is speaking audibly in the voice chat.

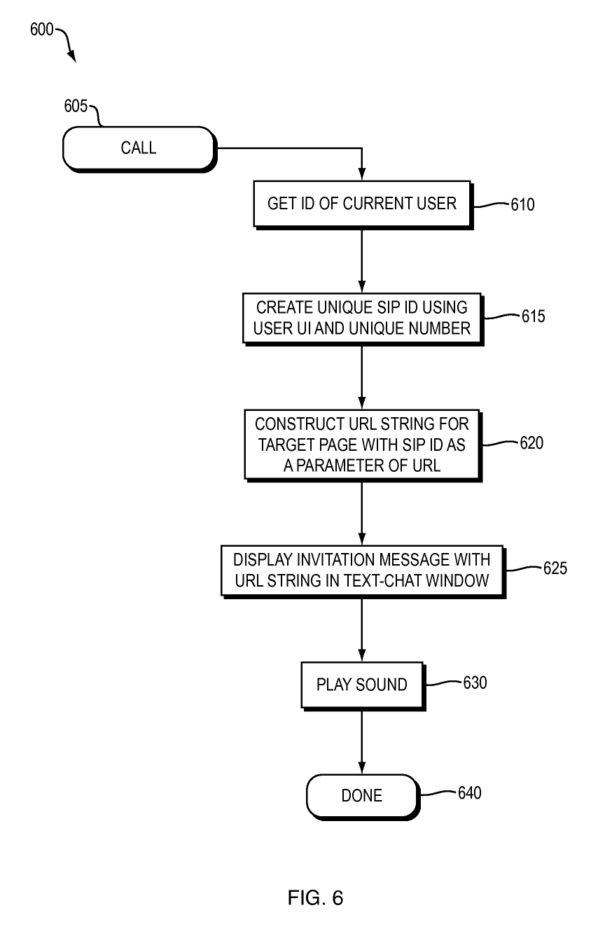

FIG. 6 at 600 illustrates in flowchart form call script 605 containing steps executed in response to the user clicking on an added UI element for initiating a voice chat call. At 610 the script obtains the Facebook ID value of the current user from information of the DOM model or browser. At 615 the script creates a unique ID for an SIP connection using a generated unique number and the ID value of the user. At 620 the script constructs a URL string for a target landing page, described below, with the SIP ID value as a parameter of the URL to be passed to the landing page. At 625, the script displays in the text chat window an invitation message containing the URL; the user may click on the URL in the text chat window to open a new browser page or tab to access the landing page. At 630, the script plays a sound calling the user's attention to the invitation message, and at 640 the script is done.

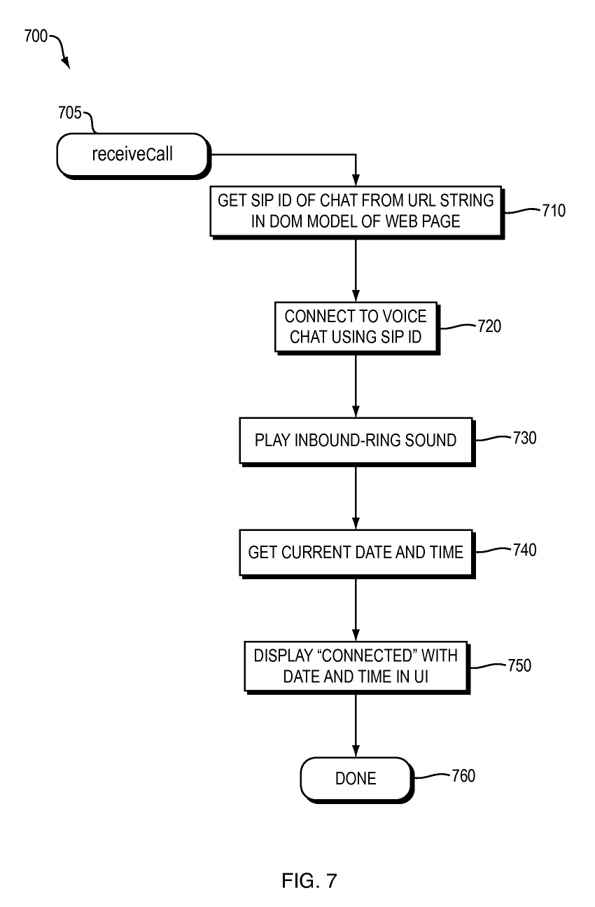

FIG. 7 at 700 illustrates in flow chart form receivecall script containing steps executed in response to the user on the added UI element for receiving a call. At 710 the script connects to the voice chat identified by the SIP ID value, and at 730 the scrip plays a sound indicating an incoming voice chat call. At 735, the script gets the current date and time from the web browser, and at 750 displays a “connected” message with the current date and time values. The script is done at 760.

In a preferred embodiment, chats may be implemented in part by flash programming, and may be accessed via a flash control of a webpage. Part of the action of the script executed via the UI element to initiate a call is to place text containing a URL in the Facebook text chat window. The URL contains a reference to and parameters for a webpage containing a flash control for accessing the chat; in this context, this webpage may be referred to as a landing page. Flash programming is known in the art and readily understood, and thus need not be described here. Information containing flash programming may be obtained at Wikipedia.

If a second Facebook user of the text chat of the text chat window has the observer/extender extension installed in that user's web browser, code of the extension observes that the URL, recognizable by content information of the URL, and modifies information of the portion of the DOM model rendered with the second user to add a UI element and an associated JavaScript function for accepting the voice chat, which may also be referred to in the present context as a call, and not to show the text of the URL. The second user can then access the chat using the added UI element.

If a second Facebook user of the text chat of the text chat window does not have the observer/extender extension installed, the web browser of the second user shows the URL itself In this circumstance, the second user can click on the URL in the second user's browser, and the browser opens a new tab or window and displays the landing page of the flash control for accessing the voice chat. The second user can access the voice chat using a UI of the flash control.

In a preferred embodiment, when a second user does not already have the extension installed in the user's browser hangs up from accessing the chat, code of the flash control webpage directs the user's browser to show a webpage from which the second user can install the extension. Details of such an embodiment are readily understood.

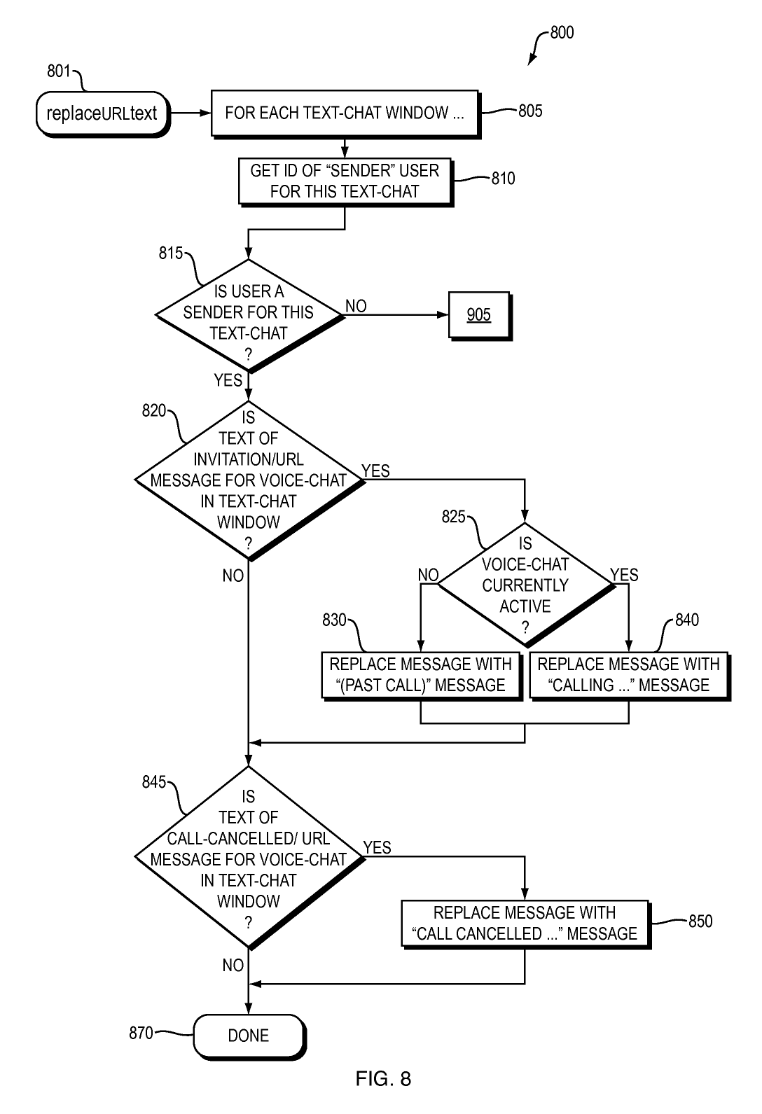

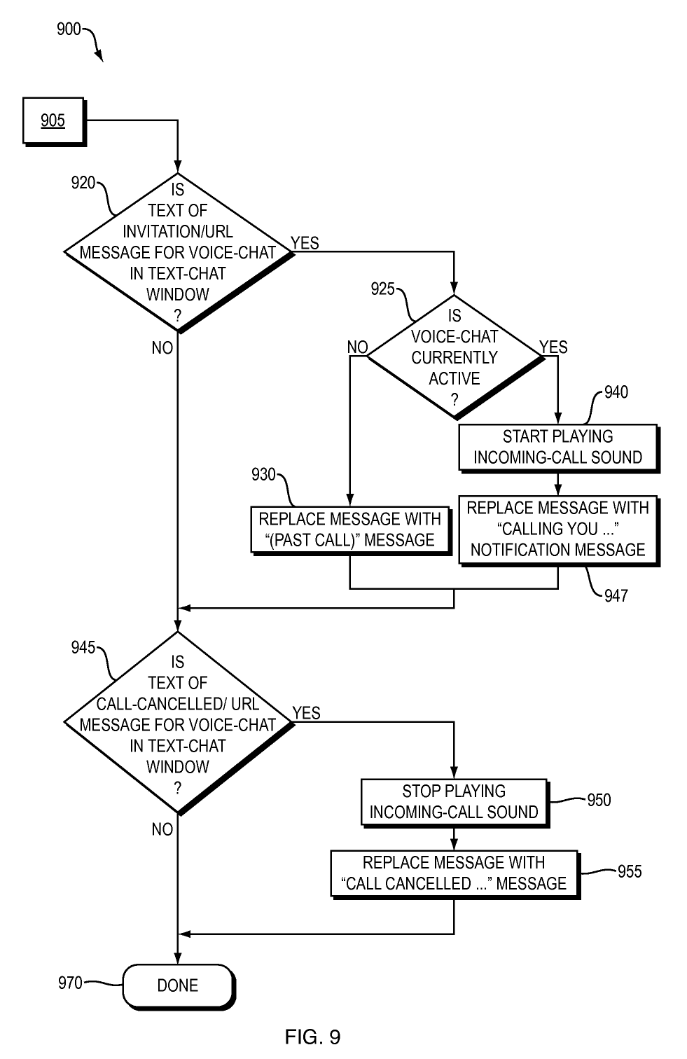

For a preferred embodiment in the case that the second user does have the extension, FIG. 8 at 800 and FIG. 9 at 900 show in flowchart form a first and second portion of exemplary script replaceURLtext 801, containing steps by which the extension recognizes an invitation message and URL text in a text chat window and modifies the DOM model make available additional UI elements for using the chat.

As shown at 805 in FIG. 8, the extension performs the steps of the script for each text chat window in the DOM model. At 810, the script gets the ID of the “sender” user of the text chat. At 815, the script determines whether the current user is the sender user of the text chat; if not, the script continues to 905 in FIG. 9. If so, at 820 the script determines whether text of the invitation/URL message for a voice chat call is in the text chat window. If not, the script continues at 845. If so, at 825 the script determines whether there is a voice chat currently active for the text chat window. If so, at 830 the script modifies information of the DOM model to replace the invitation message with a past call message indicating that a previous call is no longer active, and continues to 845. If not, at 835 a script replaces the invitation message with a calling message indicating any voice chat call is currently active, and continues to 845.

At 845, the script determines whether message text indicating that a voice chat call has been canceled is in the text chat window, and if so, at 850 replaces the message with a call canceled message. The script is done at 870.

Turning now to 905 in FIG. 9, the current user is not the sender user of the text chat; in this case, the current user is a receiver user. At 920, a script determines whether the text invitation/URL message is in the text chat window. If not, the script continues at 945. If so, at 925 the script determines whether there is a voice chat currently active with a text chat window. If not, at 930 the script replaces the invitation messages with a past call message and continues to 945. If so, at 940 the script plays an incoming message sound to draw the user's attention to an incoming call, and at 947 replaces the invitation message with a calling you notification message, and continues to 945.

At 945, the script determines whether message text indicating that a voice chat call has been canceled is in the text chat window, and if so, at 950 stops any incoming message notification sound that may be playing, and replaces the message text with a call canceled message. The script is done at 970.

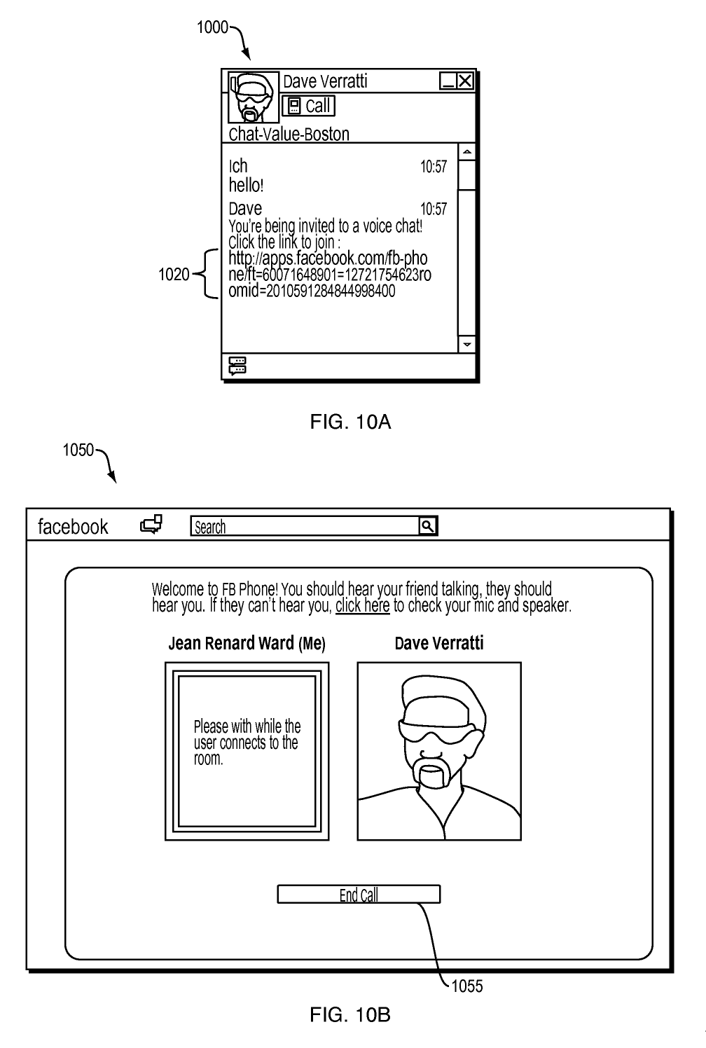

FIG. 10 at 1000 shows an exemplary text chat window when the second user does not have the extension; the invitation/URL message is shown at 1020.

FIG. 10 at 1050 shows an exemplary flash control landing page rendered by the second user's web browser after the second user has clicked on the URL of the invitation/URL message. In a preferred embodiment, the flash control landing page is a webpage of a Facebook application; details of flash programming and of implementing Facebook applications are well known.

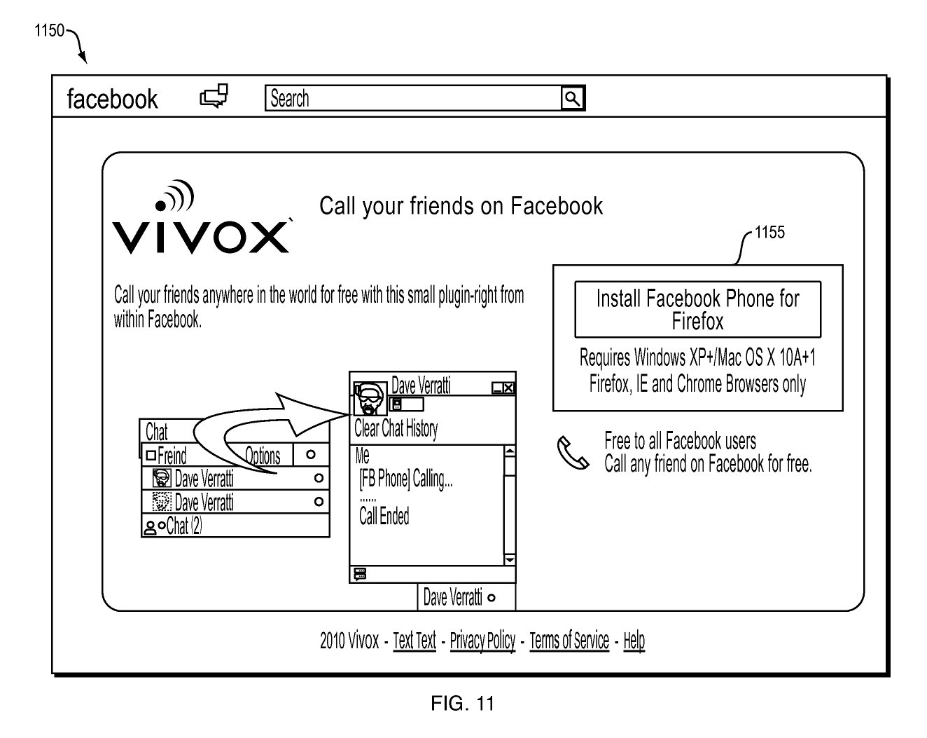

FIG. 11 at 1150 shows an exemplary webpage of a preferred embodiment for the second user to install the extension after hanging up from accessing a voice chat call. Details of installing browser extensions are well known.

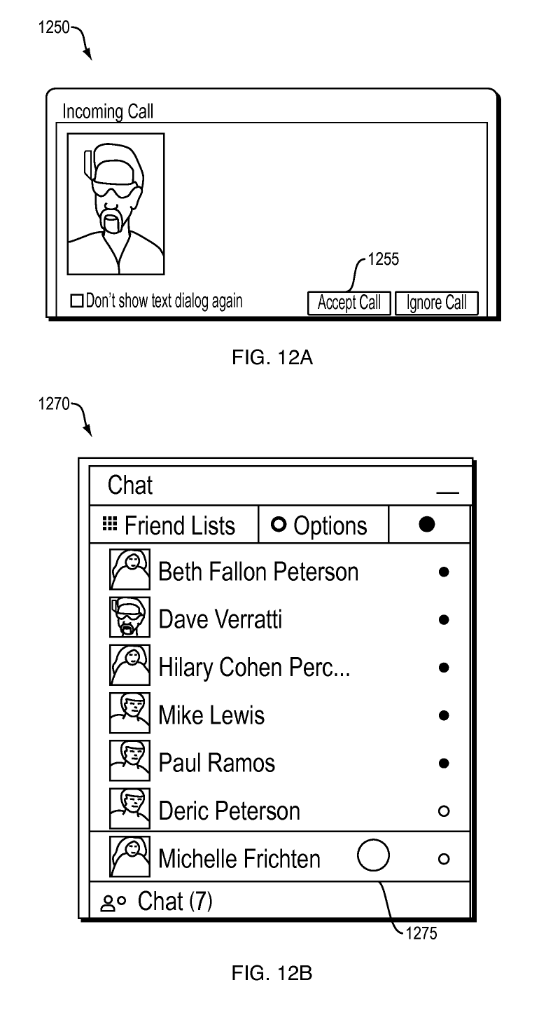

FIG. 12 at 1250 shows an exemplary UI displayed to the second user when the user does have extension installed, and code of the extension has modified the DOM model to show additional UI elements and not to show the text of the URL. The second user accepts the voice chat call by clicking on the “accept call” icon at 1255.

A further embodiment of one form of a preferred embodiment is that the extension determine from an observation that the web browser is showing the Facebook UI for showing Facebook friends of a user who are online, and modifying the DOM model of the UI to add a “call friend” UI icon for friends who are online and, in a preferred embodiment, whose browser has the extension, so that the user can initiate a chat call to a particular friend by clicking on the icon for that particular friend. An example is shown in the pixelated view at 1270 in FIG. 12; a call friend icon is visible at 1275.

Other functionalities that may be incorporated include additional UI elements and/or code to invite a number of Facebook friends to install the extension, and thus to gain convenient access to voice chats.

Of course, the extension may also perform other functionalities, including functionalities employing techniques of the chat application, as well as further functionalities.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. Accordingly, other implementations are within the scope of the following claims.

What is claimed is:

1. A method comprising:
in a computer system, extending and associating chats with execution instances of programs.
